(19) United States
(12) Patent Application Publication
(10) Pub. No.: US 2009/0274170 A1
(43) Pub. Date: Nov. 5, 2009

(54) Adaptation Apparatus and Adaptation Method for Ethernet Signal Transmission

(75) Inventors: Yang Yu, Beijing (CN); Weizhou Li, Beijing (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: HANGZHOU H3C TECHNOLOGIES CO., LTD., Hangzhou City (CN)

(21) Appl. No.: 12/501,347

(22) Filed: Jul. 10, 2009

Related U.S. Application Data
(63) Continuation of application No. PCT/CN2007/002154, filed on Jul. 13, 2007.

(30) Foreign Application Priority Data
Jan. 15, 2007 (CN) 200710002385.5
Jan. 23, 2007 (CN) 200710004087.X

(51) Int. Cl. H04J 3/22

(52) U.S. Cl. 370/466

(57) ABSTRACT

The present invention provides an adaptation apparatus for Ethernet signal transmission, including: a differential/single-ended conversion unit, set between the coaxial cable network and the Ethernet physical layer chip, adapted to convert a to-be-transmitted signal of the Ethernet physical layer chip from differential signal into single-ended signal; a non-collinear/collinear conversion unit, set between the coaxial cable network and the Ethernet physical layer chip, adapted to convert the to-be-transmitted signal from non-collinear signal into collinear signal; and transmitting means for transmitting the converted to-be-transmitted signal to the coaxial cable network. The present invention also provides an adaptation method for Ethernet signal transmission. Through the present invention, communications between an Ethernet access point and coaxial cable terminals and communications between the coaxial cable terminals are enabled so that Ethernet signals can be transmitted in coaxial cable networks.

### FIELD OF THE INVENTION

The present invention relates to communications technology, and particularly, to adaptation apparatus and adaptation method for Ethernet signal transmission.

### BACKGROUND OF THE INVENTION

Network mergence is a trend in current information communications industry. Due to reasons of technologies, history and characteristics of services, three types of networks exist in the world, and are classified by three types of services, i.e., telecommunications, broadcast and television and web services, into telecommunications network embodied by telephone networks, broadcast and television network embodied by Community Access Television or Cable Television (CATV) networks and computer network embodied by Internet. These three types of network are designed independently, and constructed and operated separately. As agreed in the industry, separate network construction results in high costs in both construction and maintenance, brings difficulties in utilizing resource efficiently and providing actual integrated service for users. In 1994, the “Word Telecommunication Development Report” of the International Telecommunications Union points out that, the three industries and respective networks, i.e. the telecommunications, the broadcast and television, and the computers, will merge to form a unified information industry. At present, with growth and deployments of techniques such as streaming media, and with emergence of services such as Internet Protocol Television (IPTV) and mobile phone television and so on, a tide of network mergence is raised again in the information communications industry, with the merging of the broadcast and television network embodied by CATV networks and the computer network embodied by Internet leading the trend.

Currently, 90% of enterprises and institutes all over the world access the computer network via Ethernet, therefore the Ethernet becomes the main approach for enterprises and institutes accessing the computer network. However, household users are more familiar with the broadcast and television network embodied by CATV networks. It has become an important task to merge networks based on existing resources. Current Ethernet is based on twisted-pair, while CATV network in China is generally based on optical fiber. CATV signals are transmitted though fibers and are received by optical receiving nodes near the users (one optical node generally covers 300˜500 adjacent users), then the optical nodes converts the optical signals into electrical signals and transmits the electrical signals to each resident building through outdoor coaxial cable system. It can be seen that, in order to transmit computer network signals through CATV networks to each user, the key task is to connect the coaxial cable system with the Ethernet.

Technical problems need be solved in implementing Ethernet signal transmission on existing CATV coaxial cable networks are as follows.

First, most existing network devices are equipped with twisted-pair-based Ethernet physical layer chips. If replacing existing CATV coaxial cable network devices for transmitting Ethernet signals, it will cost too much money and time and sacrifice the flexibility of the devices.

Ethernet physical layer access chips in the market include 10/100 M adaptive chips, Gigabit Ethernet (GE) chips and 10 GE chips. These chips are mainly capable of performing coding, Digital/Analog conversion, clock recovery and analog signal amplification on the physical layer, and include external interfaces (for analog signal) and MAC layer interfaces (for digital signal). FIG. 4 is a schematic diagram illustrating a structure of a physical layer access chip in an existing Ethernet transmitting/receiving device. As shown in FIG. 4, analog interface 110, AD/DA unit 120, clock and coding/decoding unit 130 and MAC layer interface unit 140 are connected in series. In the receiving direction, a received signals inputted through the analog interface 110 is first processed by AD/DA unit 120 for performing AD conversion to covert from analog signal to digital signal. Then the digital signal is processed by coding /decoding unit 130 for performing coding and decoding to obtain MAC layer data from the physical layer encoded data stream. The MAC layer data is processed by MAC layer interface unit 140 for performing MAC layer interface processing and then outputted. In the above process, the AD/DA conversion is performed by AD/DA unit 120 according to a standard sending voltage and a standard receiving reference electric level in the IEEE 802.3.

Second, the existing twisted-pair-based Ethernet physical layer chips are designed based on transmission characteristics of twisted-pair-based Ethernet, whose preemphasis technique of the sending end and the equalization technique of the receiving end are not applicable under the transmission characteristics of CATV coaxial cable networks. MAC layer for Ethernet signal transmission in the coaxial cable network may adopt Wireless Fidelity (WIFI) MAC or Ethernet Passive Optical Network (EPON) MAC or a Carrier Sense Multiple Access with Collision Detection (CSMA/CD) MAC. In WIFI MAC or EPON MAC, there are master nodes and backup nodes, and the backup nodes need not be connectable with each other, therefore only the mater nodes are required to be connectable with the backup nodes in the physical layer while the backup nodes need not be connectable with each other on the physical layer. Thus, these two types of MAC require the same capabilities of passing through the attenuating coaxial cable network and signals at respective receiving ends have almost the same amplitude. In contrast, CSMA/CD MAC requires that all nodes in the coaxial cable network are connectable with each other, but signals communicated between two nodes suffer from about 25 dB to 60 dB attenuation according to existing transmission techniques and devices coaxial cable networks, and signals received varies dynamically in a broad range.

Third, existing twisted-pair-based Ethernet physical layer chips can only transmit and receive differential signals instead of single-ended signals. But coaxial cable networks can only transmit single-ended signal instead of differential signals. Moreover, some twisted-pair-based Ethernet physical layer chips non-collinearly receive and transmit signals while coaxial cable networks collinearly receive and transmit signals. Therefore, it is necessary to solve the problem of non-collinear/collinear conversion for the Ethernet physical layer chips.

To sum up, the main problem of the prior art lies in that the twisted-pair-based Ethernet physical layer chips can not receive Ethernet signals transmitted via coaxial cable systems due to the differences in transmission characteristics of the twisted-pair-based Ethernet physical layer chips and CATV coaxial cable networks.

### SUMMARY OF THE INVENTION

The present invention provides adaptation apparatus and adaptation method for Ethernet signal transmission to transmit Ethernet signals in existing coaxial cable networks.

To achieve the above objective, an embodiment of the present invention provides an adaptation apparatus for Ethernet signal transmission, applicable for signal transmission between a coaxial cable network and a twisted-pair-based Ethernet physical layer chip, including: a differential/single-ended conversion unit, set between the coaxial cable network and the Ethernet physical layer chip, adapted to convert a to-be-transmitted signal of the Ethernet physical layer chip from differential signal into single-ended signal; a non-collinear/collinear conversion unit, set between the coaxial cable network and the Ethernet physical layer chip, adapted to convert the to-be-transmitted signal from non-collinear signal into collinear signal; and transmitting means for transmitting the converted to-be-transmitted signal to the coaxial cable network.

An embodiment of the present invention provides an adaptation apparatus for Ethernet signal transmission, applicable to signal transmission between a coaxial cable network and a twisted-pair-based Ethernet physical layer chip capable of transmitting and receiving signal collinearly, including:
a differential/single-ended conversion unit, set between the coaxial cable network and the Ethernet physical layer chip, adapted to convert a to-be-transmitted signal of the Ethernet physical layer chip from differential signal into single-ended signal;
a transmitting end amplifying unit, set between the coaxial cable network and the Ethernet physical layer chip, adapted to amplify the to-be-transmitted signal according to an amplification coefficient; and
transmitting means for transmitting the converted to-be-transmitted signal to the coaxial cable network.

An embodiment of the present invention provides an adaptation method for Ethernet signal transmission, applicable to signal transmission between a coaxial cable network and a twisted-pair-based Ethernet physical layer chip, including:
converting a to-be-transmitted signal of the Ethernet physical layer chip from differential signal into single-ended signal; convert the to-be-transmitted signal from non- collinear signal into collinear signal; and transmitting the to-be-transmitted signal to the coaxial cable network.

An embodiment of the present invention provides an adaptation method for Ethernet signal transmission, including:
converting a received signal from the coaxial cable network from collinear signal into non-collinear signal; converting the received signal from single-ended signal into differential signal; and transmitting the received signal to the Ethernet physical layer chip.

Compared with the prior art, embodiments of the present invention have advantages including:
enabling Ethernet baseband signals to be transmitted Point to Multipoint through attenuating coaxial cable splitters and distributors in existing coaxial cable network; enabling communications between an Ethernet access point and coaxial cable terminals and communications between coaxial cable terminals, so that CSMA/CD MAC can be adopted to transmit Ethernet signals in coaxial cable networks. In addition, techniques such as single-ended/differential signal conversion and collinear/non-collinear conversion are adopted to make full use of conventional coaxial cable networks for Ethernet signal transmission.

### BRIEF DESCRIPTION OF THE DRAWINGS

FIG. 1 is a schematic diagram illustrating attenuation of signals on different transmission frequencies through twisted pair cables with different parameters.

FIG. 2 is a schematic diagram illustrating interfaces of a 2-way splitter of the prior art.

FIG. 3 is a schematic diagram illustrating attenuation of signals on different frequencies transmitted by a splitter in a coaxial cable network.

FIG. 4 is a schematic diagram illustrating a structure of a physical layer device in a Ethernet transceiver according to the prior art.

FIG. 5 is a schematic diagram illustrating an adaptation apparatus for Ethernet signal transmission according to an embodiment of the present invention.

FIG. 6 is a schematic diagram illustrating an adaptation method for Ethernet signal transmission according to an embodiment of the present invention.

FIG. 7 is a schematic diagram illustrating an adaptation method for Ethernet signal transmission according to an embodiment of the present invention.

### DETAILED DESCRIPTION OF THE INVENTION

Transmission characteristics of twisted-pair-based Ethernet and CATV networks, and current transmission techniques and devices of CATV networks will be described in the following to reveal technical problems to be solved for implementing transmission of Ethernet signals in CATV networks.

I. transmission characteristics of the physical layer and the Media Access Control (MAC) layer of the Ethernet will be described.

### The Physical Layer of the Ethernet

Twisted-pair-based Ethernet transmission has four main transmission characteristics in the physical layer as follows.

First, twisted-pair-based Ethernet is based on baseband transmission, thus occupies a wider spectrum. For example, 10 Mbps Ethernet occupies a spectrum ranging from OHz to 20 MHz, while 10 Mbps Ethernet and 1000 Mbps Ethernet occupy a spectrum ranging from 0 Hz to several hundred MHz depending on different Ethernet devices.

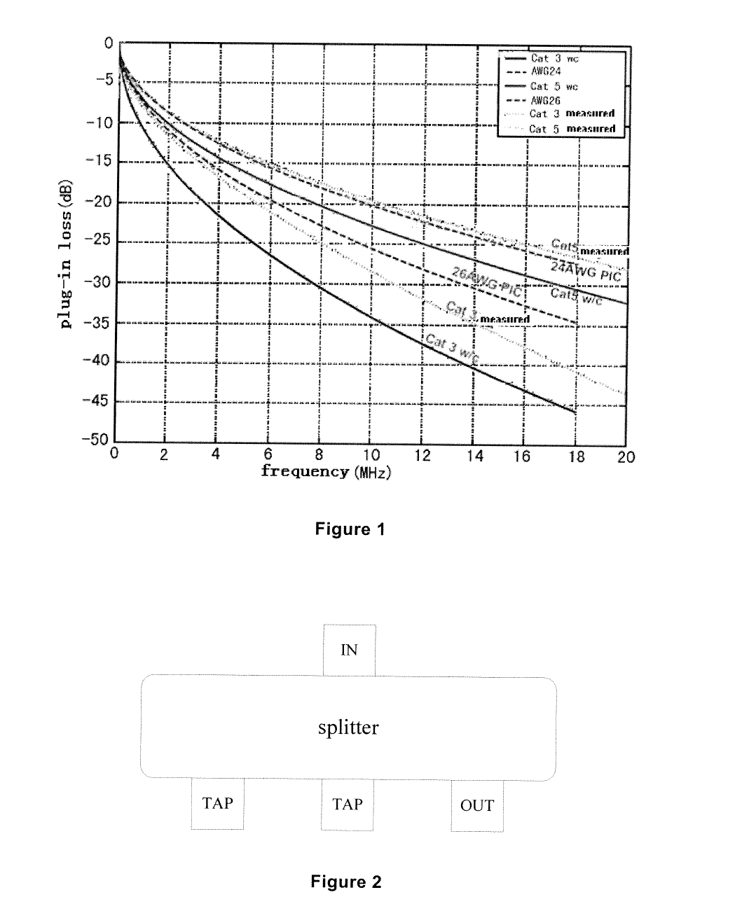

Second, FIG. 1 is a schematic diagram illustrating attenuation of signals of different transmission frequencies (from 0 Hz to 20 MHz) through cables with different parameters (such as Cat 3 or Cat 5 line) in a 300-meter twisted pair. FIG. 1 shows that, in the Cat 5 line, attenuation of a 4 MHz signal is 15 dB while attenuation of a 20M Hz signal reaches about 32 dB. It can be seen that, twisted-pair signals on different frequencies have different attenuation when traveling the same distance.

In view of the above transmission characteristics of twisted-pair, current Ethernet chips are usually equipped with preemphasis technique of a transmitting end and equalization technique of a receiving end to compensate the difference in transmission attenuation of physical layer signals on different frequencies on the same medium during Ethernet baseband transmission. Main functions of the preemphasis technique of the transmitting end and the equalization technique of the receiving end include: amplifying signals on different frequencies differently at the transmitting end to compensate different transmission attenuation in the twisted pair; applying the equalization technique to different frequency components in signals received at the receiving end to compensate the attenuation.

Third, in twisted-pair-based Ethernet signal transmission, differential signals are transmitted and received to reduce and restrain external interferences.

The differential signals referred to mean that: one line transmits signals in a positive electric level, while another line transmits the same signals in a negative electric level. When there is interference in the lines, the interference will have the same effect on the signals in the two lines. Therefore, when the differential signals are recovered in the receiving end, the interference can be canceled (it can be regarded as performing subtraction between the two differential signals).

Fourth, the physical layer chip of 10/100 Mbps twisted-pair-based Ethernet transmits and receives signal non-collinearly, i.e. signals are transmitted and a received through different lines.

### The MAC Layer of the Ethernet

The MAC layer of current Ethernet works in a CSMA/CD mode. Basic principles of the CSMA/CD mode lie in that: the CSMA/CD is a distributed MAC protocol, each node in the network can decide independently the transmission and receipt of a data frame. Before transmitting a data frame, each node performs carrier sense firstly, and is allowed to transmit the data frame only when the medium is available. If at least two nodes simultaneously detect that the medium is available and transmit respective frames, a collision will occur which invalidate the frames, thus the transmission is failed. Each node must have the capability of detecting at any moment whether a collision takes place and stopping transmission once there is a collision so as to avoid a waste of medium bandwidth resulted in transmitting invalid frames. The node then re-attempts the medium again after a random time period to re-transmit the frame.

According to the above principles, the CSMA/CD mode requires that each node sharing the medium can receive a signal from another node and that if the node detects that another node is occupying the shared medium for sending a signal, the node delays its own transmission and transmits signals in a next appropriate time.

II. transmission techniques and devices of current CATV coaxial cable network in the broadcast and television system and transmission characteristics will be described in the following.

Current transmission techniques and devices of CATV coaxial cable networks in the broadcast and television system

In current CATV coaxial cable networks of China, television programs are transmitted via optical fibers to optical nodes close to users in the television network (one optical node generally covers 300˜500 adjacent users). The optical nodes convert the optical signals to electrical signals and then transmit the electrical signals to each resident building through an outdoor coaxial cable system.

The resident building is taken as an example to illustrate current transmission techniques and devices of the CATV coaxial cable networks and the transmission characteristics thereof. Suppose that each resident building is equipped with a building amplifier to amplify television signals so as to compensate signal attenuation during transmission. Taking a six-storey resident building having six units and each unit having twelve households as an example, the television signals amplified by the building amplifier are then evenly distributed to the six units by a 6-way distributor. In each unit, a two-way splitter is set in each floor to split the television signals for the two households on each floor.

In order to ensure the television signals for each household has the same amplitude (because all households should receive the same amplitude of television signals), the attenuation of splitters of each floor should be different to cancel the difference between far-end users and near-end users in the attenuations of television signals through the splitters and coaxial cable. For example, since signals are usually transmitted from the first floor to the sixth floor, signals for the first floor which is on the near end of the signal transmission, need not pass through the splitters and transmission cable, therefore the splitter of the first floor should have the highest attenuation, such as 18 dB; the splitter of the second floor has relatively lower attenuation, such as 16 dB; and splitters of the other floors may be deduced by analogy. In this way, television signals for each household have the same attenuation after being transmitted to twelve households through a tree-shaped network irrespective of the different transmission paths and distances, therefore the televisions of all households in the resident building receive television signals with the same signal amplitude.

FIG. 2 is a schematic diagram illustrating interfaces of a 2-way splitter according to the prior art. As shown in FIG. 2, the splitter includes an IN port, an OUT port and two TAP ports. Signals are inputted through the IN port and is split and outputted to the OUT port and the TAP ports with different output attenuation. The attenuation of the OUT port is the lowest and the attenuations of the two TAP ports are the same and are both higher than that of the OUT port.

In practice, television signals are inputted to the IN port of the 2-way splitter of the first floor, and are outputted to two households on the first floor through the two TAP ports and to the IN port of the splitter of the second floor through the OUT port. The television signals are then outputted to the two households on the second floor through the two TAP ports of the splitter of the second floor and to the splitter of the third floor through the OUT port of the splitter of the second floor, and by analogy for the other floors.

Among parameters of a splitter, the signal attenuation between the IN port and the OUT port is called a plug-in loss, while the signal attenuation between the IN port and each TAP port is called a splitting loss, the signal attenuation between the OUT port and each TAP port is called a reverse isolation loss, and the signal attenuation between the two TAP ports is called a mutual isolation loss.

Table 1 lists parameters of a 2-way splitter product sample in the prior art. The first row under the title “Performance” lists splitters with different splitting attenuation (8 dB˜20 dB respectively). As shown in Table 1, different splitters have different splitting attenuation, thus can be adopted on different floors.

TABLE 1
prior art 2-way splitter product parameter table

| Item | | | Unit | Performance | | | | | | |
|---|---|---|---|---|---|---|---|---|---|---|
| Splitting | Rated value | | dB | 8 | 10 | 12 | 14 | 16 | 18 | 20 |
| loss | Error | | | ±1.5 | | | | | | |
| Plug-in loss | (5~65) | MHz | dB Max. | 3.5 | 2.7 | 1.8 | 1.7 | 1.3 | 1.1 | 1.0 |
| | (65~550) | MHz | | 3.8 | 2.9 | 1.8 | 1.9 | 1.4 | 1.3 | 1.1 |
| | (550~750) | MHz | | 3.8 | 2.9 | 1.9 | 1.9 | 1.6 | 1.4 | 1.1 |
| | (750~1000) | MHz | | 4.0 | 3.3 | 2.0 | 2.0 | 1.7 | 1.6 | 1.1 |
| Reverse | (5~65) | MHz | dB Min. | 25 | 28 | 28 | 30 | 32 | 32 | 34 |
| isolation | (65~550) | MHz | | 28 | 28 | 28 | 30 | 32 | 32 | 34 |
| | (550~750) | MHz | | 28 | 28 | 28 | 30 | 32 | 32 | 34 |
| | (750~1000) | MHz | | 25 | 25 | 25 | 25 | 28 | 28 | 30 |
| Mutual | (5~65) | MHz | dB Min. | 25 | 28 | 28 | 28 | 28 | 28 | 30 |
| isolation | (65~550) | MHz | | 30 | 30 | 30 | 32 | 32 | 32 | 32 |
| | (550~750) | MHz | | 28 | 30 | 30 | 30 | 30 | 30 | 30 |
| | (750-1000) | MHz | | 25 | 25 | 25 | 25 | 25 | 25 | 25 |

| | | | | |
|---|---|---|---|---|
| Reflection | (5~65) | MHz | dB Min. | 16 |
| loss | (65~550) | MHz | | 16 |
| | (550~750) | MHz | | 16 |
| | (750~1000) | MHz | | 14 |

| | | |
|---|---|---|
| Electromagnetic shielding | dB Min. | 110 |
| coefficient | | |

Taking a 2-way splifter with 8 dB splitting loss as an example, as shown in Table 1, signals transmitted from the IN port to the OUT port have the lowest attenuation, which is 3.5 dB for 5˜65 MHz;signals transmitted from the IN port to the two TAP ports have the second lowest attenuation, which is 8 dB; attenuation of signals transmitted between the two TAP ports, i.e. the signal loss between two users, is higher, which is 25 dB for 5˜65 MHz.

Taking the above CATV network topology of the resident building as an example, where the six-storey resident building has six units and each unit has 12 households, amplified television signals are distributed evenly to the six units by a 6-way distributor. In each unit, each floor has a 2-way splitter which splits the television signals to two households of each floor. In this topology, attenuation of signals in the above CATV network is about 31 dB, which is approximately the sum of attenuation of a 6-way distributor (9 dB), splitters of five different floors and a 2-way distributor of the sixth floor (18 dB), and about 50-meter coaxial closed circuit line (35 meters in corridors plus 15 meters indoors) (10 dB for high frequency 1000 MHz). The sum of signal attenuation is 9 dB+18 d+10 dB=37 dB theoretically, but in the practice the result is generally lower than 31 dB. Therefore, if the output of the building amplifier is 100 dB V, the signal received by each television on the user end is 69 dB V.

### Transmission Characteristics of the Catv Coaxial Cable Network

When transmitting Ethernet signals utilizing a CATV coaxial cable network, transmission characteristics of the CATV coaxial cable network mainly include the following four aspects.

First, Ethernet over CATV coaxial cable network plays an important role in merging CATV coaxial cable networks and computer networks, and Ethernet over CATV coaxial cable network characterizes in its frequency deployment. In existing broadcast and television standard of China, frequency band for CATV coaxial cable networks is 5 MHz˜1 GHz, where the frequency band from 65 MHz to 1 GH is for television program channels, and the frequency band from 5 MHz to 65 MHz is for bidirectional data channels.

According to the above channel distribution, when Ethernet baseband signals and television programs are simultaneously transmitted in the coaxial cable system, only the frequency resources lower than 65 MHz are available for the Ethernet baseband signals because the Ethernet baseband signals should not disturb the transmission of television programs. However, in the frequency resources lower than 65 MHz, only 10 Mbps Ethernet can be transmitted (occupying 20 MHz) according to current Ethernet transmission rate, while the 100 Mbps Ethernet (occupying 125 MHz) cannot be transmitted. If 100 Mbps Ethernet is to be transmitted, the frequency band higher than 65 MHz will be occupied which will affect the transmission of television programs.

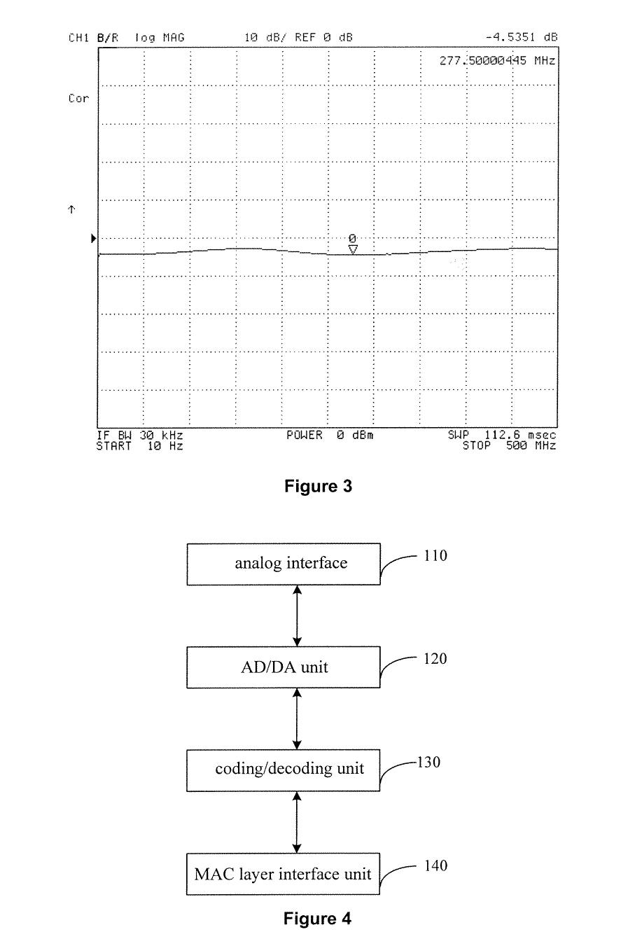

Second, CATV coaxial cable networks of the broadcast and television system also characterize in transmission attenuation. CATV coaxial cable network is a coaxial cable network with attenuation, but the attenuation characteristics are different from the earliest bus topology network without attenuation and are also different from existing twisted-pair-based Ethernet. FIG. 3 is a schematic diagram illustrating signal attenuation of a splitter in a CATV coaxial cable network of a broadcast and television system, where the horizontal axis indicates frequencies and the vertical axis indicates attenuation. As shown in FIG. 3, the attenuation of different transmission frequencies in the CATV coaxial cable network of the broadcast and television system is in an almost straight line, i.e. the attenuation of different transmission frequencies is almost the same. Thus attenuation manner of the CATV coaxial cable network of the broadcast and television system is completely different from that of the Ethernet.

Based on the existing transmission techniques and devices, the CATV coaxial cable network of the broadcast and television system also characterizes in that the attenuation between different nodes is different. In the above example of the CATV coaxial cable network of the broadcast and television system, the attenuation from the building amplifier to each household is about 30 dB, and the attenuation between households is at least 25 dB which can even reach about 60 dB. The attenuation between two branch users of one splitter (equals the mutual isolation parameter of the splitter) is between 25 dB and 30 dB. The attenuation between different branches of different splitters equals the reverse isolation parameter plus the splitting loss parameter, which is between 40 dB and 60 dB. Therefore, if communications between branch nodes (representing users) are required, the attenuation to be dealt with is between 25 dB and 60 dB.

Third, different from twisted pair which transmits differential signals, the coaxial cable system can only transmit a single-ended signal.

Fourth, different from some twisted pairs which non-collinearly send and receive signals, the coaxial cable network sends and receives signals through the same coaxial cable system.

Based on the above analysis on the transmission characteristics of the physical layer and MAC layer of the Ethernet and existing transmission techniques and devices of the CATV coaxial cable network in the broadcast and television system and the transmission characteristics thereof, embodiment of the present invention provide adaptation apparatus and adaptation method for Ethernet signal transmission, which enable receiving and transmitting signals between a CATV coaxial cable network and an Ethernet by modifying an Ethernet physical layer transceiver. The adaptation apparatus and the adaptation method will be described hereinafter in detail with reference to the embodiments and the accompanying drawings.

In this embodiment, a procedure of signal processing is described by taking a coaxial cable network topology of a six-storey resident building having six units as an example. Suppose that the CATV coaxial cable network includes a 6-way distributor and six splitters (STZ218, STZ216, STZ214, STZ212, STZ210 and STZ208 respectively), thus attenuation of the CATV coaxial cable network may be calculated based on parameters of each components: a 6-way distributor (9 dB), five splitters of different floors and a 2-way splitter of the sixth floor (18 dB), about 50-meter (35 meters outdoors plus 15 meters indoors) coaxial cable (2 dB, according to the attenuation of high frequency 5˜65 MHz), and thus the attenuation is about 29 dB theoretically.

According to the parameters of the transmission techniques and devices of existing CATV coaxial cable network, a dynamic range of received signals can be calculated. Specifically, attenuation between two branch interfaces of one splitter is the lowest while attenuation between different branch interfaces of different splitters is the highest, and the dynamic range of received signals can be obtained based on limiting values in the above two cases, for example, the calculated dynamic range of received signals may be 29 dB˜60 dB.

Due to signal attenuation in CATV coaxial cable networks, it is necessary to perform signal amplification to increase signal amplitude. When the Ethernet adopts EPON MAC or WIFI MAC, only a root node is required to be connected with each branch node respectively while the branch nodes are not required to be connected with each other. Meanwhile, the attenuation between the root node and each branch node is basically the same in uplink and downlink directions; therefore, the network attenuation is 29 dB according to the above attenuation calculated. In this case, it is only necessary to increase amplitude of signals to be transmitted and received by 29 dB through the signal amplification.

When the Ethernet adopts CSMA/CD MAC, since all the branch nodes are also required to be connected with each other, and attenuation between the branch nodes changes dynamically, for example 29 dB˜60 dB according to the above calculation, which is far higher than the attenuation between the root node and branch node, a counteracting step is necessary, i.e. detecting received signal attenuation and amplify the signal according to the attenuation detected.

According to the transmission characteristics of CATV coaxial cable networks, the Ethernet adopting CSMA/CD MAC may amplify a network signal at the transmitting end according to the maximum attenuation in order to ensure that all network nodes can receive signal. Therefore, based on the above calculation, the network signal may be amplified by 60 dB according to the above calculation at the transmitting end; at the receiving end, a received signal may be detected first, attenuation of the signal is calculated based on the detected amplitude of the received signal, then an amplification coefficient can be determined for the received signal, and the received signal is amplified according to the amplification coefficient.

The amplification coefficient may be calculated according to a formula as follows:

voltage attenuation=201 g(Vx/Vo),

where Vx is an input voltage and Vo is an output voltage.

As can be seen from the above formula, when the voltage attenuation is 29 dB, Vx/Vo=28.18; when the voltage attenuation is 60 dB, Vx/Vo=1000. For signal transmission in 50-meter coaxial cable distribution network with no splitter attenuation where the voltage attenuation is only about 2 dB, Vx/Vo=1.25.

Therefore, suppose that an Ethernet signal access point has an input voltage Vx=1V, the output voltage will be 0.79V when the attenuation is 2 dB; the output voltage will be 0.035V when the attenuation is 29 dB and the output voltage will be 0.001V when the attenuation is 60 dB.

In the above cases, if the input voltage amplitude of the Ethernet signal access point is 1V, the signal amplitude received by each coaxial cable terminal will be 0.035V. Similarly, when a signal transmitted by each coaxial cable terminal has an output amplitude of 1V, the input amplitude of the signal received by the Ethernet will also be 0.035V. But the signal outputted to other coaxial cable terminals has a maximum amplitude of 0.035V and a minimum amplitude of 0.001V. Therefore, the amplification coefficient is determined by the maximum attenuation loss between the coaxial cable terminals so that the receiving end under the maximum attenuation (e.g. 60 dB) can receive the signal from the coaxial cable distribution network. Preferably, the amplification coefficient may enable the receiving end to receive a voltage signal conforming to IEEE 802.3 standard, so that decoding at the receiving end will not be affected.

If the physical layer chip can only identify a signal whose amplitude is not smaller than 0.5V, when voltage attenuation is 60 dB, i.e. Vx/Vo=1000, the output voltage of the physical layer chip should be amplified to 500V at the inputting end. Therefore, amplifiers are necessary in access points and physical layer chips at the outputting end of coaxial cable terminals to increase signal amplitude transmitted.

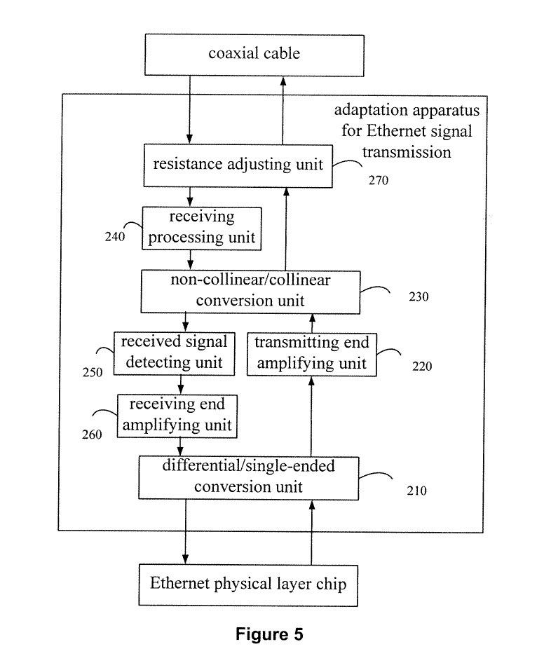

Based on the above analysis, FIG. 5 shows a schematic diagram illustrating a structure of an adaptation apparatus for Ethernet signal transmission according to an embodiment of the present invention. Being an adaptation apparatus between a coaxial cable network and an Ethernet, one end of the apparatus is connected with the coaxial cable network and the other end is connected to an Ethernet physical layer chip. The adaptation apparatus includes components for amplifying and converting signals received and to be transmitted. The physical layer chip may be a physical layer access chip in the Ethernet transceiver shown in FIG. 4.

In order to describe differences with the prior art, the structure of the adaptation apparatus for Ethernet signal transmission is described in transmitting direction and receiving direction respectively according to an embodiment of the present invention.

In transmitting direction of a signal, i.e. the direction of transmitting the signal from the Ethernet to the coaxial cable network, after transmitted by the Ethernet physical layer chip and before received by the coaxial cable network, the signal goes through the following units in the adaptation apparatus.

A differential/single-ended conversion unit 210, adapted to convert a differential signal transmitted by the Ethernet physical layer chip to a single-ended signal. The conversion may include taking any one of the two signals Tx+ and Tx− transmitted in the twisted pair as a transmitting signal.

A transmitting end amplifying unit 220, adapted to amplify electrical level of a to-be-transmitted signal inputted to the transmitting end amplifying unit 220. When the Ethernet adopts EPON MAC or WIFI MAC, the amplitude of the to-be-transmitted signal is amplified by 29 dB according to the network attenuation calculated above. When the Ethernet adopts CSMA/CD MAC, according to the dynamic range of attenuation between branch nodes, e.g. 29 dB˜60 dB as calculated above, the network signal is amplified according to the maximum attenuation at the transmitting end of the Ethernet, i.e. 60 dB as calculated above.

A non-collinear/collinear conversion unit 230, adapted to convert a non-collinear signal received to a collinear signal when the twisted-pair-based Ethernet physical layer chip receives and transmits signal non-collinearly, because some twisted-pair-based Ethernet physical layer chip receives and transmits signal non-collinearly while the coaxial cable network transmits and receives signal using one coaxial cable. The non-collinear/collinear conversion unit 230 may directly connect a transmitting line and a receiving line through 2/4 line conversion. If the Ethernet physical layer chip is capable of transmitting and receiving signal collinearly, this unit may be omitted when implementing this embodiment.

In the receiving direction, i.e. the direction of transmitting a signal from the coaxial cable network to the Ethernet physical layer chip, after being transmitted from the coaxial cable network and before received by the Ethernet physical layer chip, the signal goes through the following units in the adaptation apparatus of the present invention.

A receiving processing unit 240, adapted to selectively receive a signal from the coaxial cable network according to a pre-set electrical level threshold for receiving signals. The electrical level threshold for receiving signals is determined by the maximum attenuation between coaxial cable terminals. Further, voltages lower than the maximum attenuation loss between the coaxial cable terminals will be filtered out to avoid unnecessary interference.

A non-collinear/collinear conversion unit 230, adapted to convert a collinear signal received from the coaxial cable network into a non-collinear signal if the twisted-pair-based Ethernet physical layer chip receives and transmits signal non-collinearly. With respect to connections, the connection between the non-collinear/collinear conversion unit 230 and the coaxial cable network should be given priority in order to make the receiving and transmitting channels shortest. Similarly, if the Ethernet physical layer chip is capable of transmitting and receiving signal collinearly, this unit may be omitted when implementing this embodiment.

A received signal detecting unit 250, adapted to detect the attenuation of an electrical level of the signal received, and determine an amplification coefficient for the signal according to the attenuation detected.

A receiving end amplifying unit 260, connected with the received signal detecting unit 250 in the receiving direction, adapted to self-adaptively adjust the amplification coefficient according to the attenuation of the electrical level detected by the received signal detecting unit 250, and amplify the signal received to make signals received have the same output electrical level. The selection of the amplification coefficient has been described in the above.

The differential/single-ended conversion unit 210, adapted to convert a single-ended signal transmitted by the coaxial cable network into a differential signal. The conversion may be implemented by a conventional differential/single-ended signal conversion circuit.

In addition, because the twisted pair of the Ethernet is a 100-ohm differential parallel load while the coaxial cable is a 75-ohm single-ended load, load adjustment should also be taken into account when designing. As shown in FIG. 5, the adaptation apparatus is connected to the coaxial cable through a resistance adjusting unit 270 which adjusts a physical layer load into 75 ohm. The location of the resistance adjusting unit 270 may change according to demands.

Through the adaptation apparatus for Ethernet signal transmission in the above embodiment of the present invention, the baseband Ethernet can be transmitted Point to Multipoint through the attenuating coaxial splitters and distributors in current coaxial cable network; communications between the access point of the Ethernet and the coaxial cable terminals and communications between the coaxial cable terminals are enabled, and Ethernet signals can be transmitted in coaxial cable network adopting CSMA/CD MAC. In addition, techniques such as the single-ended/differential signal conversion and the collinear/non-collinear conversion are adopted to make full use of existing coaxial cable networks for Ethernet signal transmission.

An embodiment of the present invention further provides an adaptation method for Ethernet signal transmission. The adaptation method is described hereinafter in transmitting direction and receiving direction respectively.

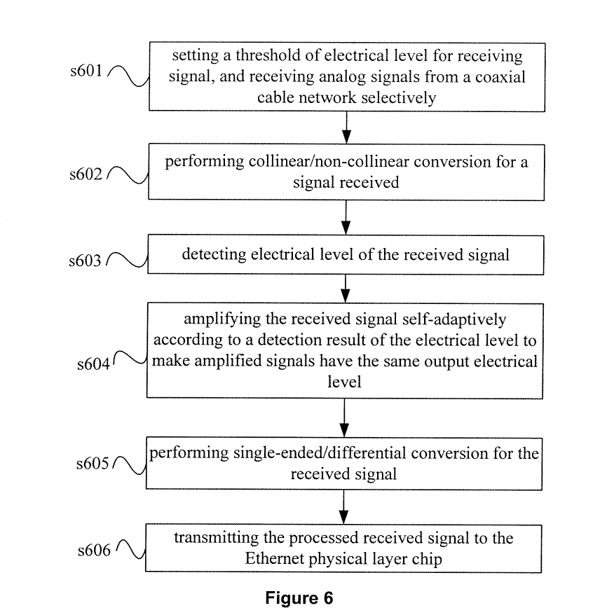

The signal transmission method in the receiving direction (the direction of transmitting a signal from the coaxial cable network to the Ethernet) may include the following steps as shown in FIG. 6.

In step s601, an electrical level threshold for receiving signal is set, and analog signals from a coaxial cable network is selectively received.

In step s602, collinear/non-collinear conversion is performed for a signal received from the coaxial cable network.

This step is optional, i.e., if an Ethernet physical layer chip has the ability to receive and transmit signals collinearly, this step can be omitted.

In step s603, electrical level of the received signal is detected.

In step s604, the received signal is self-adaptively amplified according to a detection result of the electrical level to make amplified signals have the same output electrical level.

In step s605, single-ended/differential conversion is performed for the received signal.

In step s606, the processed received signal is transmitted to the Ethernet physical layer chip.

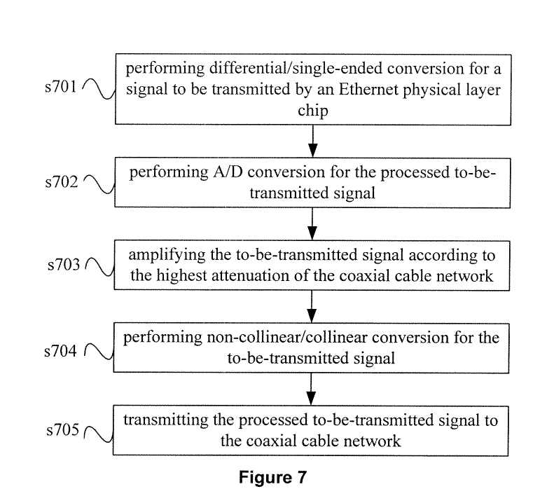

The signal transmission method in the transmitting direction (the direction of transmitting a signal from the Ethernet to the coaxial cable network) may include the following steps as shown in FIG. 7.

In step s701, differential/single-ended conversion is performed for a signal to be transmitted by an Ethernet physical layer chip.

In step s702, A/D conversion is performed for the processed to-be-transmitted signal.

In step s703, the signal is amplified according to the maximum attenuation of the coaxial cable network.

In step s704, non-collinear/collinear conversion is performed for the signal.

This step is optional, i.e. if the Ethernet physical layer chip has the ability to receive and transmit signals collinearly, this step can be omitted.

In step s705, the processed signal is transmitted to the coaxial cable network.

Through the above adaptation method, baseband Ethernet is enabled to be transmitted Point to Multipoint through attenuating coaxial cable splitters and distributors in existing coaxial cable networks; communications between Ethernet access points and coaxial cable terminals and communications between coaxial cable terminals are enabled; and Ethernet signals are enabled to be transmitted using CSMA/CD MAC in coaxial cable networks. In addition, techniques such as single-ended/differential signal conversion and collinear/non-collinear conversion are adopted to make full use of existing coaxial cable networks for transmitting Ethernet signals.

The foregoing is only embodiments of the present invention. The protection scope of the present invention, however, is not limited to the above description. Any change or substitution, easily occurring to those skilled in the art, should be covered by the protection scope of the present invention.

What is claimed is:

1. An adaptation apparatus for Ethernet signal transmission, applicable to signal transmission between a coaxial cable network and a twisted-pair-based Ethernet physical layer chip, comprising:
a differential/single-ended conversion unit, set between the coaxial cable network and the Ethernet physical layer chip, adapted to convert a to-be-transmitted signal of the Ethernet physical layer chip from differential signal into single-ended signal;
a non-collinear/collinear conversion unit, set between the coaxial cable network and the Ethernet physical layer chip, adapted to convert the to-be-transmitted signal from non- collinear signal into collinear signal; and
transmitting means for transmitting the converted to-be-transmitted signal to the coaxial cable network.

2. The adaptation apparatus of claim 1, further comprising:
a transmitting end amplifying unit, set between the Ethernet physical layer chip and the coaxial cable network, adapted to amplify the to-be-transmitted signal according to an amplification coefficient before the to-be-transmitted signal is transmitted to the coaxial cable network.

3. The adaptation apparatus of claim 2, wherein the transmitting end amplifying unit is adapted to determine the amplification coefficient based on a maximum attenuation loss of the coaxial cable network.

4. The adaptation apparatus of claim 1, further comprising:
a resistance adjusting unit, set between the coaxial cable network and the Ethernet physical layer chip, adapted to adjust a load of the Ethernet physical layer.

5. The adaptation apparatus of claim 1, wherein
the non-collinear/collinear conversion unit is further adapted to convert a received signal from the coaxial cable network from collinear signal into non-collinear signal;
the differential/single-ended conversion unit is further adapted to convert the received signal from single-ended signal into differential signal;
the transmitting means is further for transmitting the converted received signal to the Ethernet physical layer chip.

6. The adaptation apparatus of claim 5, further comprising:
a received signal detecting unit, connected to the coaxial cable network, adapted to detect an electrical level of the received signal from the coaxial cable network and obtain the amplification coefficient based on a detection result;
a receiving end amplifying unit, set between the coaxial cable network and the Ethernet physical layer chip, adapted to amplify the received signal according to the amplification coefficient obtained by the received signal detecting unit before the received signal is transmitted to the Ethernet physical layer chip.

7. The adaptation apparatus of claim 5, further comprising:
a receiving processing unit, set between the coaxial cable network and the Ethernet physical layer chip, adapted to selectively receive a signal from the coaxial cable network according to a pre-set electrical level threshold for received signals.

8. An adaptation apparatus for Ethernet signal transmission, applicable to signal transmission between a coaxial cable network and a twisted-pair-based Ethernet physical layer chip capable of transmitting and receiving signal collinearly, comprising:
a differential/single-ended conversion unit, set between the coaxial cable network and the Ethernet physical layer chip, adapted to convert a to-be-transmitted signal of the Ethernet physical layer chip from differential signal into single-ended signal;
a transmitting end amplifying unit, set between the coaxial cable network and the Ethernet physical layer chip, adapted to amplify the to-be-transmifted signal according to an amplification coefficient; and
transmitting means for transmitting the converted to-be-transmifted signal to the coaxial cable network.

9. The adaptation apparatus of claim 8, further comprising:
a received signal detecting unit, set between the coaxial cable network and the Ethernet physical layer chip, adapted to detect an electrical level of the received signal from the coaxial cable network and obtain a second amplification coefficient based on a detection result;
a receiving end amplifying unit, set between the coaxial cable network and the Ethernet physical layer chip, adapted to amplify the received signal according to the second amplification coefficient obtained by the received signal detecting unit;
wherein
the differential/single-ended conversion unit is further adapted to convert the received signal from single-ended signal into differential signal; and
the transmitting means is further for transmitting the converted received signal to the coaxial cable network.

10. The adaptation apparatus of claim 8, further comprising:
a receiving processing unit, set between the coaxial cable network and the received signal detecting unit, adapted to selectively receive a signal from the coaxial cable network according to a pre-set electrical level threshold for received signals.

11. The adaptation apparatus of claim 8, further comprising:
a resistance adjusting unit, set between the coaxial cable network and the Ethernet physical layer chip, adapted to adjust a load of the Ethernet physical layer.

12. An adaptation method for Ethernet signal transmission, applicable to signal transmission between a coaxial cable network and a twisted-pair-based Ethernet physical layer chip, comprising:
converting a to-be-transmitted signal of the Ethernet physical layer chip from differential signal into single-ended signal;
convert the to-be-transmitted signal from non-collinear signal into collinear signal; and
transmitting the to-be-transmitted signal to the coaxial cable network.

13. The adaptation method of claim 12, further comprising:
amplifying the to-be-transmitted signal according to an amplification coefficient before transmitting the to-be-transmitted signal to the coaxial cable network.

14. The adaptation method of claim 13, wherein the amplification coefficient is obtained based on a maximum attenuation loss of the coaxial cable network.

15. The adaptation method of claim 14, wherein
the amplification coefficient is obtained based on an attenuation between an Ethernet access point and a coaxial cable terminal when Wireless Fidelity (WIFI) MAC or Ethernet Passive Optical Network (EPON) MAC is adopted for Ethernet signal transmission, or is obtained based on an attenuation between coaxial cable terminals when Carrier Sense Multiple Access with Collision Detection (CSMA/CD) MAC is adopted for Ethernet signal transmission.

16. An adaptation method for Ethernet signal transmission, applicable to signal transmission between a coaxial cable network and a twisted-pair-based Ethernet physical layer chip, comprising:
converting a received signal from the coaxial cable network from collinear signal into non-collinear signal;
converting the received signal from single-ended signal into differential signal; and
transmitting the received signal to the Ethernet physical layer chip.

17. The adaptation method of claim 16, further comprising:
amplifying the received signal according to a second amplification coefficient obtained based on a detection result of electrical level of the signal before transmitting the received signal to the Ethernet physical layer chip.

18. The adaptation method of claim 16, further comprising:
setting an electrical level threshold for receiving signals and selectively receiving a signal from the coaxial cable network.

19. The adaptation method of claim 16, further comprising:
adjusting a load of the Ethernet physical layer.
